(19) United States
(12) Patent Application Publication
(10) Pub. No.: US 2007/0226058 A1
(43) Pub. Date: Sep. 27, 2007

(54) Time based electronic advertisement

(75) Inventors: Matthew L. Lorenzen, Cupertino, CA (US); Lee Lorenzen, Pacific Grove, CA (US); Craig W. Johnson, Portola Valley, CA (US); Micah S. Siegel, Palo Alto, CA (US)

Correspondence Address: VAN PELT, YI & JAMES LLP, 10050 N. FOOTHILL BLVD #200, CUPERTINO, CA, 95014, US

(73) Assignee: MyWare, Inc.

(21) Appl. No.: 11/508,556

(22) Filed: Aug. 22, 2006

Related U.S. Application Data
(60) Provisional application No. 60/784,835, filed on Mar. 21, 2006.
(60) Provisional application No. 60/802,050, filed on May 18, 2006.

(51) Int. Cl. G06Q 30/00

(52) U.S. Cl. 705/14

(57) ABSTRACT

Determining performance of an electronic advertisement is disclosed. Data associated with a measured time of the electronic advertisement is received. The received data is analyzed to determine a performance value of the advertisement. In some cases, the performance value is associated with a time based electronic advertisement cost model.

### CROSS REFERENCE TO OTHER APPLICATIONS

This application claims priority to U.S. Provisional Patent Application No. 60/784,835 (Attorney Docket No. MYWAP001+) entitled ENHANCED CONTENT MANAGER filed Mar. 21, 2006, which is incorporated herein by reference for all purposes and U.S. Provisional Patent Application No. 60/802,050 (Attorney Docket No. MYWAP002+) entitled ENHANCED CONTENT MANAGER filed May 18, 2006, which is incorporated herein by reference for all purposes.

### BACKGROUND OF THE INVENTION

CPA (cost per action) electronic advertising cost model has been recognized as an improvement over the traditional CPC (cost per click) electronic advertising cost model. With CPC, an advertiser is charged on the basis of a click on an advertisement, whereas with CPA, an advertiser pays for an advertisement when an advertiser defined action that more closely correlates with a desired result of the advertiser is performed. An example of the action is a purchase of the advertiser's product. Additionally, CPA is not prone to click fraud associated with CPC (e.g., when an entity clicks on competing advertisements to waste advertising resources of a competitor). In many cases, an advertisement is not directly associated with a click or an action, and/or an advertiser does not desire a click or an action associated with an advertisement (e.g., an advertisement directed at brand name recognition). Some advertisement distributors do not offer a CPA advertisement cost model based on a desire to be compensated for displaying an advertisement. In such cases, CPM (cost per impression) is a common advertising cost model used. However an impression (e.g., display of an advertisement) does not guarantee a user has viewed the advertisement or how much attention has been given to the advertisement by the user. Additionally, CPM is prone to fraud similar to click fraud associated with CPC. Therefore, there exists a need for a better way to track and optimize cost model of electronic advertising.

### BRIEF DESCRIPTION OF THE DRAWINGS

Various embodiments of the invention are disclosed in the following detailed description and the accompanying drawings.

FIG. 1 is a block diagram illustrating an embodiment of an enhanced content environment.

FIG. 2 is a flowchart illustrating an embodiment of a process for determining and processing an advertisement associated with enhanced content.

FIG. 3 is a flowchart illustrating an embodiment of a process for processing a measured time associated with an advertisement.

FIG. 4 is a flowchart illustrating an embodiment of a process for performing processing associated with a received advertisement interaction data.

FIG. 5 is a flowchart illustrating an embodiment of a process for optimizing one or more advertisements using analysis results.

### DETAILED DESCRIPTION

The invention can be implemented in numerous ways, including as a process, an apparatus, a system, a computer readable medium such as a computer readable storage medium or a computer network wherein program instructions are sent over optical or communication links. In this specification, these implementations, or any other form that the invention may take, may be referred to as techniques. A component such as a processor or a memory described as being configured to perform a task includes both a general component that is temporarily configured to perform the task at a given time or a specific component that is manufactured to perform the task. In general, the order of the steps of disclosed processes may be altered within the scope of the invention.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

A time based electronic advertising cost model is disclosed. In some embodiments, an advertiser is billed based on a measured time associated with an advertisement. For example, an advertiser is billed based on how long an advertisement has been displayed and/or how long a user has interacted with an advertisement (e.g., length of advertisement video watched). In some embodiments, the measured time is analyzed to optimize one or more advertisements.

Often when browsing a webpage, additional information related to an item of the webpage is desired. For example, a definition of a word found on the webpage or directions to an address found on the webpage is desired. To obtain the desired information, typically a user selects a link, if provided, on the webpage and/or performs a search for the desired information. Although a provided link can be a convenient in some cases, a link is often not provided for the desired information. In many cases, the provided link leads to incorrect, undesired, and/or unpreferred information, causing the user to backtrack to the originating webpage to pursue other search options (e.g., a user may prefer a specific electronic map provider not linked on the originating webpage). The process of searching for the desired information requires the user to leave the originating webpage or open a new browsing window. In addition to the hassle of the search process, juggling various webpages and/or various windows can be inconvenient, especially when information is quickly desired and/or desired without interrupting the browsing of the originating webpage. Enhanced content can be used to obtain such desired information.

In some cases, a user desires to specify a desired information provider. For example, a user may prefer one provider to provide a map for an address on a webpage, but another to provide a definition of a word or a program for dialing a phone number. In some embodiments, an enhanced content manager gives users the choice of which enhanced content provider should be used to provide particular information on a webpage without requiring the user to leave the webpage. The enhanced content manager manages configuration, processing, and/or display of enhanced content. In some embodiments, content included on the webpage that is to be enhanced is associated with enhanced content from a specified enhanced content provider previously specified from among a plurality of enhanced content providers. For example, user-desired enhanced content associated with one or more user-indicated portions of the webpage is overlaid on the webpage in a display bubble. The enhanced content provider provides at least a portion of the enhanced content to an entity processing and/or displaying the enhanced content. Types of enhanced content include one or more of the following: text, image, link, audio, video, data input field, and various other multimedia and web content. Examples of enhanced content include one or more of the following: a preview of a link, an advertisement, a definition, a translation, an article, a search result, directory information, a stock quote, a map, a navigation direction, a satellite image, a street level image, weather information, a review of a product, data enabling purchase of a product and/or service, and data enabling communication (e.g., telephonic call, video conference, instant message, text message, email, fax). The overlaid enhanced content is displayed without using and/or altering encoding of the webpage. For example, the overlaid enhanced content is displayed without altering the underlying markup language and scripting language encoding (e.g., HTML, XML, Java Script, AJAX, etc.) used by a web browser to render the webpage. A user may indicate a portion of the web page by selecting text or pausing over a link, as well as other methods. In some embodiments, the enhanced content is selected by using a user indication (e.g., a selection of item on a context specific shortcut menu) specifying which enhanced content category should be associated with the content to be enhanced.

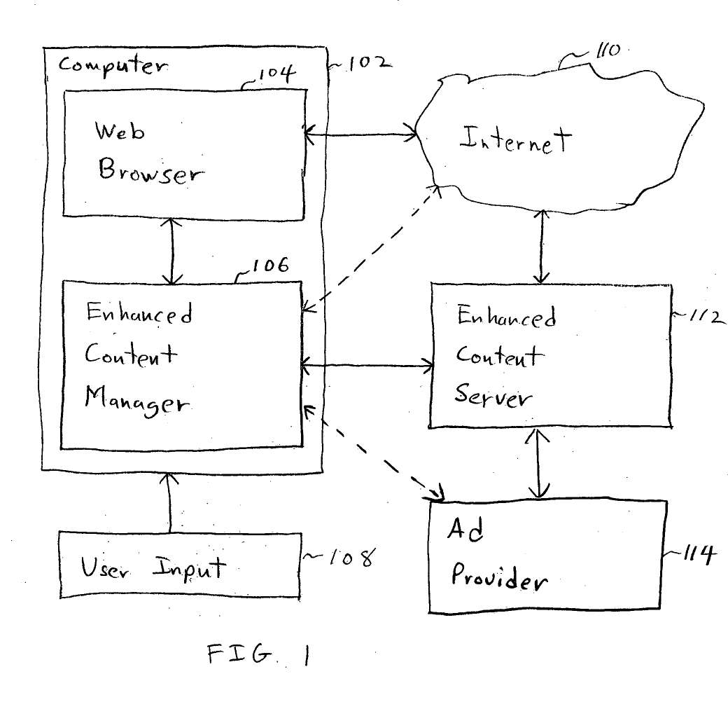

FIG. 1 is a block diagram illustrating an embodiment of an enhanced content environment. Computer 102 receives user input 108 from, for example, a keyboard and/or a curser pointing device. Computer 102 includes web browser 104 and enhanced content manager 106. Web browser 104 is used by a user of computer 102 to display web content. Web browser 104 accesses Internet 110 to obtain web content. Enhanced content manager 106 manages enhanced content associated with at least a portion of a webpage displayed by web browser 104. Managing enhanced content includes obtaining enhanced content and/or managing configurations/preferences associated with enhanced content. In various embodiments, enhanced content manager 106 is included in and/or executed in computer 102 as one or more of the following: a web browser plug-in, an application program, a background software process, an imbedded function of a web browser, and an imbedded function of an operating system.

Data is communicated between web browser 104 and enhanced content manager 106. For example, data indicating web browser content to be enhanced is communicated between web browser 104 and enhanced content manger 106. In some embodiments, user interaction data associated with computer 102 is communicated between enhanced content manager 106 and enhanced content server 112. Examples of user interaction data includes data associated with one or more of the following: an identifier of a desired enhanced content, a menu selection, a web content selection, an advertisement tracking information, and a user input (e.g., cursor movement, cursor selection, keyboard input). In some embodiments, by receiving user interaction data from multiple enhanced content managers, enhanced content server 112 can aggregate and/or process user interaction data from multiple users. In some embodiments, at least a portion of the enhanced content obtained by enhanced content manger 106 is received from enhanced content server 112. Enhanced content server 112 is connected to Internet 110 and can obtain content from Internet 110. For example, at least a portion of enhanced content requested by enhanced content manager 106 is returned by enhanced content server 112 by obtaining content from an enhanced content provider accessed through Internet 110. In some embodiments, enhanced content server 112 provides cached data to enhanced content manager 106. In some embodiments, at least a portion of the enhanced content is obtained by enhanced content manager 106 is obtained directly from an enhanced content provider through Internet 110.

In some embodiments, an advertisement is associated with the enhanced content. The advertisement is provided to enhanced content manager 106 by advertisement provider 114 either directly by ad provider 114 or through enhanced content server 112. Ad provider 114 uses data provided by enhanced content manager 106 and/or enhanced content server 112 to return an advertisement responsive to the content to be enhanced. In some embodiments, enhanced content server 112 and ad provider 114 are parts of a single system. In some embodiments, ad provider 114 is associated with an entity that aggregates advertisements. In some embodiments, the advertisement is provided by an enhanced content provider along with the desired enhanced content. Enhanced content manager 106 sends data that can at least in part be used to track the performance of an advertisement to a tracking entity such as enhanced content server 112 and/or ad provider 114. For example, a user interaction with an advertisement (e.g., selection of an advertisement) is tracked by enhanced content manger 106 and sent to enhanced content server 112 for anonymous aggregation. For example, during user interaction data aggregation, enhanced content server 112 removes information that can be used to identify a specific user. The aggregated information for the advertisement is used to determine an advertisement cost billed to an advertiser.

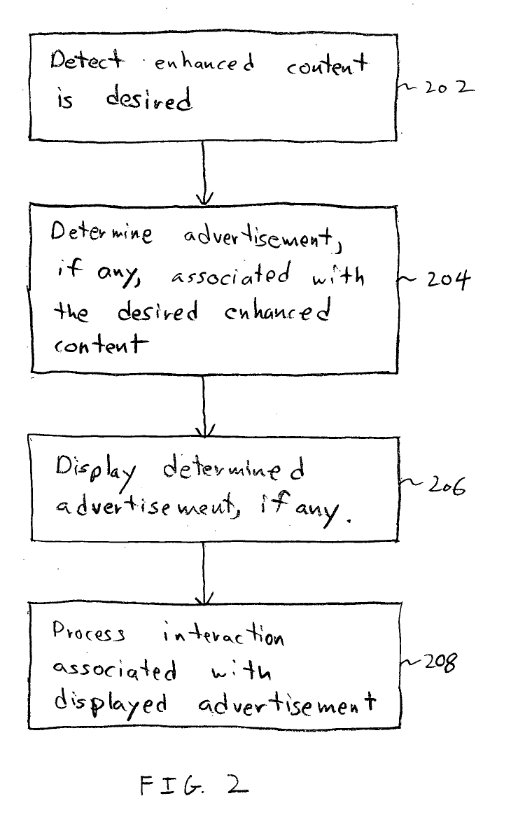

FIG. 2 is a flowchart illustrating an embodiment of a process for determining and processing an advertisement associated with enhanced content. At 202, a desire for enhanced content is detected. Detecting that enhanced content is desired includes receiving an indication associated with content to be enhanced. In various embodiments, a user indicates a portion of content in one or more of the following ways: highlighting desired content, underlining desire content, selecting (e.g., clicking, touching) desired content with a cursor/pointer, pausing over desired content with a cursor/pointer, and gesturing (e.g., circling, boxing, underlining) desired content with a cursor/pointer. The cursor/pointer can be controlled by a user by using one or more of the following: a mouse, a touch pad, a pointing stick, a tablet, a joystick, a keyboard, a touch screen device, and any pointing device. The indication of the content to be enhanced is at least in part used to obtain the desired enhanced content from an enhanced content provider.

At 204, an advertisement, if any, associated with the desired enhanced content is determined. The indicated content to be enhanced and/or enhanced content obtained from the enhanced content provider is used to determine the advertisement. For example, an advertisement responsive to a keyword found in the indicated content to be enhanced and/or enhanced content obtained from the enhanced content provider is obtained. In another example, if a user has indicated content with an address to be enhanced with a map of the address, the address is used to obtain an advertisement of a business located near the address. In some embodiments, one or more rules are used in determining the advertisement. The rule is based at least in part on analysis of indicated content to be enhanced and/or enhanced content obtained from the enhanced content provider. For example, a rule may specify that a competing advertisement is not to be displayed for indicated content that includes another advertisement. In some embodiments, user data is used at least part to determine the advertisement. Examples of user data include user demographics information, history of past user actions, enhanced content configuration data, and web browser configuration data. In some cases, no advertisement associated with the desired enhanced content exists. In various embodiments, the advertisement determination is made by enhanced content manager 106 by using enhanced content server 112 and/or ad provider 114 of FIG. 1.

At 206, the determined advertisement, if any, is displayed. The determined advertisement is displayed in association with the determined enhanced content. For example, the advertisement is overlaid on the content to be enhanced in the same display area containing the enhanced content. In some embodiments, the advertisement is obtained from an enhanced content provider along with the enhanced content. At 208, interaction associated with the displayed advertisement is processed. Processing the interaction includes monitoring user behavior associated with the advertisement. For example, user cursor/pointer behavior over the advertisement is monitored. Information associated with the interaction is sent to an entity managing and aggregating user interactions with the advertisement. The managing entity may use the interaction data to calculate an advertisement cost for the advertisement. In some embodiments, a plurality of advertisement interactions is aggregated before being sent to the tracking entity.

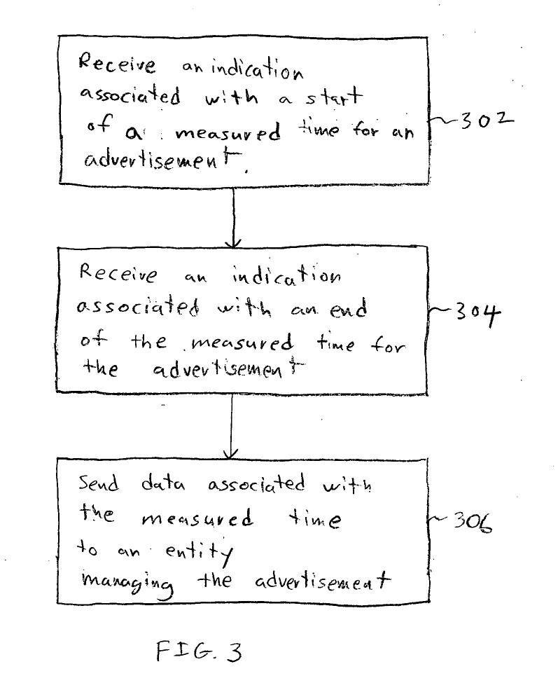

FIG. 3 is a flowchart illustrating an embodiment of a process for processing a measured time associated with an advertisement. The process of FIG. 3 is associated with a time based electronic advertisement cost model. In some embodiments, the process of FIG. 3 is included in 208 of FIG. 2. At 302, an indication associated with a start of a measured time for the advertisement is received. Start of the measured time is associated with one or more of the following: beginning a display of an advertisement, selecting (e.g. clicking) of advertisement content, hovering over advertisement content, starting of advertisement video content, starting of advertisement multimedia content, starting advertisement audio content, starting of animated advertisement content, and starting of interactive advertisement content. At 304, an indication associated with an end of the measured time for the advertisement is received. The end of the measured time for the advertisement is associated with one or more of the following: closing of an advertisement display, selecting content of the advertisement indicating end of user interaction with the advertisement, ending cursor hover over the advertisement, selecting content outside a display area associated with the advertisement, hovering over content outside a display area associated with the advertisement, leaving a webpage associated with the advertisement, closing of a web browser window associated with the advertisement, and stopping, pausing, or ending content of the advertisement.

In some cases, there exists a maximum measured time, and no indication associated with the end of the measured time is required to determine the measured time. In some cases, the measured time is associated with the amount of time an advertisement has been displayed and/or the amount time advertisement content has been played. At 306, data associated with the measured time is sent to an entity managing the advertisement. In some embodiments, the entity managing the advertisement is enhanced content manager 112 of FIG. 1. In some embodiments, the entity managing the advertisement is advertisement provider 114 of FIG. 1. The entity managing the advertisement performs processing using the measured time data. In various embodiments, the entity managing the advertisement performs one or more of the following using the measured time data: anonymously aggregate measured time data, track the performance of the advertisement, optimize a future advertisement to be displayed, determine a value that can be used to determine an advertisement cost associated with the advertisement, and perform an operation associated with billing for the advertisement.

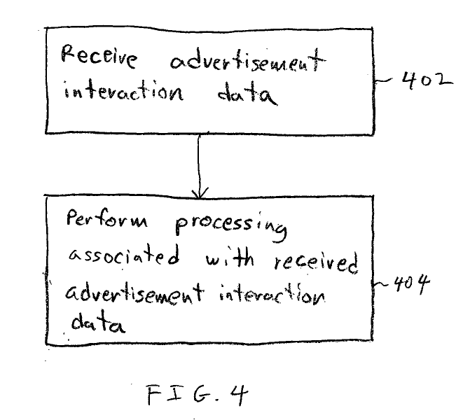

FIG. 4 is a flowchart illustrating an embodiment of a process for performing processing associated with a received advertisement interaction data. In some embodiments, the process of FIG. 4 is implemented in enhanced content server 112 or advertisement provider 114 of FIG. 1. At 402, advertisement interaction data is received. In some embodiments, the interaction data is the processed interaction data in 208 of FIG. 2. In some embodiments, the interaction data is the sent data associated with the measured time in 306 of FIG. 3. At 404, processing associated with the received advertisement interaction data is performed. Processing the received advertisement interaction data includes performing one or more of the following: anonymously aggregating interaction data of an advertisement, tracking the performance of the advertisement using the interaction data, optimizing a future advertisement to be displayed using the interaction data, determining a value that can be used to determine an advertisement cost associated with the advertisement, and perform an operation associated with billing for the advertisement.

In some embodiments, the interaction data includes time based data associated with the advertisement. In some cases, an advertiser is billed a time based rate multiplied by a measured time. In some cases, an advertiser is billed by a graduated time rate (e.g. certain segments of measured time billed at a higher rate). In some cases, an advertiser is billed based on the percentage value associated with a measured time (e.g., percentage of time the measured time is compared to a predetermined total time). In some cases, there exists a maximum for the amount of measured time that can be billed for each user interaction with the advertisement. In some cases, an advertiser is not billed for a user interaction with the advertisement until a measured time has exceeded a threshold time.

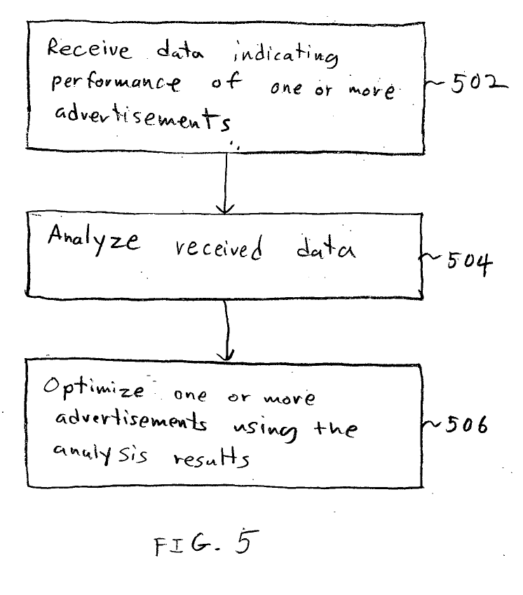

FIG. 5 is a flowchart illustrating an embodiment of a process for optimizing one or more advertisements using analysis results. In some embodiments, the process of FIG. 5 is implemented in advertisement provider 114 of FIG. 1. At 502, data indicating performance of one or more advertisements is received. In some embodiments, the performance data is received from enhanced content manager 106 of FIG. 1. The performance data includes user interaction data associated with the advertisement. The user interaction data may be time based. For example, the amount of time associated with user attention to an advertisement is received from one or more users. In some embodiments, the performance data includes performance data associated with user demographics. At 504, the received data is analyzed. Analyzing the received data includes aggregating performance data from a plurality of users and comparing performance of various advertisements. In some embodiments, the analysis includes correlating advertisement performance data with associated user demographics information. At 506, one or more advertisements are optimized using the analysis results. Optimizing the advertisements includes performing one or more of the following: removing an advertisement from being displayed, generating an advertisement to be displayed, modifying an advertisement to be displayed, selecting an advertisement to display from a plurality of available advertisements, determining a preferred advertisement for a specified user demographics.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A method of determining performance of an electronic advertisement, comprising:
receiving data associated with a measured time of the electronic advertisement; and
analyzing the received data to determine a performance value of the advertisement.

2. A method as recited in claim 1, wherein the performance value is associated with a time based electronic advertisement cost model.

3. A method as recited in claim 1, wherein analyzing the received data to determine the performance value of the advertisement includes aggregating at least a portion of the received data with at least a portion of another previously received data.

4. A method as recited in claim 1, wherein analyzing the received data to determine the performance value of the advertisement includes removing information identifying a user associated with the received data.

5. A method as recited in claim 1, wherein the performance value is a value associated with a plurality of measured times.

6. A method as recited in claim 1, wherein the performance value can be used at least in part to determine an advertisement cost of the electronic advertisement.

7. A method as recited in claim 6, wherein the advertisement cost is at least in part calculated by multiplying a time based rate by a time value associated with the performance value.

8. A method as recited in claim 7, wherein the time based rate is a graduated rate.

9. A method as recited in claim 6, wherein each advertisement interaction contributing to the advertisement cost is limited by a maximum cost value.

10. A method as recited in claim 6, wherein each advertisement interaction contributing to the advertisement cost is associated with a measured time exceeding a threshold time value.

11. A method as recited in claim 1, wherein the measured time is associated with an amount of time the advertisement was displayed.

12. A method as recited in claim 1, wherein the measured time is associated with an amount of time the advertisement was played.

13. A method as recited in claim 1, wherein the measured time is associated with an amount of time a user has interacted with the advertisement.

14. A method as recited in claim 1, wherein the measured time is measured starting from one of the following events: beginning a display of the advertisement, selecting content of the advertisement, hovering over the advertisement with a cursor, and starting video, multimedia, audio, animated, or interactive content of the advertisement.

15. A method as recited in claim 1, wherein the measured time is measured ending at is one of the following events: closing of an advertisement display, selecting content of the advertisement indicating end of user interaction with the advertisement, ending cursor hover over the advertisement, selecting content outside a display area associated with the advertisement, hovering over content outside a display area associated with the advertisement, leaving a webpage associated with the advertisement, closing of a web browser window associated with the advertisement, and stopping, pausing, or ending content of the advertisement.

16. A method as recited in claim 1, wherein the measured time is limited by a maximum time value.

17. A method as recited in claim 1, wherein the performance value is a percentage value associated with the measured time.

18. A method as recited in claim 1, further comprising correlating the performance value with user demographics information.

19. A method as recited in claim 1, the performance value can be used to optimize one or more advertisements.

20. A method as recited in claim 19, wherein optimizing the one or more advertisements includes performing one or more of the following: removing an advertisement from being displayed, generating an advertisement to be displayed, modifying an advertisement to be displayed, selecting an advertisement to display from a plurality of available advertisements, determining a preferred advertisement for a specified user demographics.

21. A method as recited in claim 1, wherein the advertisement is associated with enhanced content displayed in response to an indication specifying at least portion of a webpage to be enhanced.

22. A method as recited in claim 21, wherein the advertisement is responsive to at least a portion of the enhanced content.

23. A method as recited in claim 21, wherein the advertisement is responsive to at least a portion of the webpage content to be enhanced.

24. A method as recited in claim 21, wherein the advertisement is responsive to one or more of the following: user demographics information, history of past user actions, enhanced content configuration data, and web browser configuration data

25. A method as recited in claim 21, wherein the enhanced content and the advertisement are displayed together without using and without altering encoding of the webpage.

26. A method as recited in claim 21, wherein the enhanced content selected at least in part by using a user indication specifying which enhanced content category should be associated with the portion of the webpage to be enhanced.

27. A method as recited in claim 1, wherein the advertisement is overlaid on a webpage in a display bubble.

28. A system for determining performance of an electronic advertisement, comprising:
a processor configured to receive data associated with a measured time of the electronic advertisement, and analyze the received data to determine a performance value of the advertisement; and
a memory coupled with the processor, wherein the memory is configured to provide the processor with instructions.

29. A system as recited in claim 28, wherein the performance value is associated with a time based electronic advertisement cost model.

30. A system as recited in claim 28, wherein the processor analyzes the received data including by removing information identifying a user associated with the received data.

31. A system as recited in claim 28, wherein the performance value can be used at least in part to determine an advertisement cost of the electronic advertisement.

32. A system as recited in claim 28, wherein the processor is further configured to correlate the performance value with user demographics information.

33. A system as recited in claim 28, the performance value can be used to optimize one or more advertisements.

34. A computer program product for determining performance of an electronic advertisement, the computer program product being embodied in a computer readable medium and comprising computer instructions for:
receiving data associated with a measured time of the electronic advertisement; and
analyzing the received data to determine a performance value of the advertisement.

35. A computer program product as recited in claim 34, wherein the performance value is associated with a time based electronic advertisement cost model.

36. A computer program product as recited in claim 34, wherein analyzing the received data to determine the performance value of the advertisement includes removing information identifying a user associated with the received data.

37. A computer program product as recited in claim 34, wherein the performance value can be used at least in part to determine an advertisement cost of the electronic advertisement.

38. A computer program product as recited in claim 34, further comprising correlating the performance value with user demographics information.

39. A computer program product as recited in claim 34, the performance value can be used to optimize one or more advertisements.
